(19) United States
(12) Patent Application Publication
(10) Pub. No.: US 2008/0169631 A1
(43) Pub. Date: Jul. 17, 2008

(54) Laminated inflatable vehicle occupant protection device construction

(75) Inventor: Bruce R. Hill, Bloomfield Hills, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/654,335

(22) Filed: Jan. 17, 2007

(51) Int. Cl. B60R 21/235

(52) U.S. Cl. 280/743.1

(57) ABSTRACT

An inflatable vehicle occupant protection device (14) includes a one piece woven substrate (102) that defines an inflatable volume (60) of the protection device. Permeability reducing layers (100) are applied to an outer surface (110) of the substrate (102). The permeability reducing layers (100) include a first permeability reducing layer (100) comprising an adhesive film (104) extruded onto the outer surface (110) of the substrate (102) and a second permeability reducing layer (106) applied over the adhesive film.

### FIELD OF THE INVENTION

The present invention relates to a laminated inflatable vehicle occupant protection device for helping to protect an occupant of a vehicle.

### BACKGROUND OF THE INVENTION

It is known to inflate an inflatable vehicle occupant protection device to help protect a vehicle occupant. Examples of inflatable vehicle occupant protection devices include driver and passenger frontal air bags, side air bags, and inflatable knee bolsters. One particular type of inflatable vehicle occupant protection device is an inflatable curtain.

An inflatable curtain will inflate in response to the occurrence of an event for which inflation of the inflatable curtain is desired, such as a side impact to the vehicle, a vehicle rollover, or both. The inflatable curtain inflates away from a roof of the vehicle between a side structure of the vehicle and a vehicle occupant. A known inflatable curtain is inflated by inflation fluid directed from an inflator to the inflatable curtain via a fill tube.

Inflatable curtains may have a variety of constructions. One particular construction for an inflatable curtain construction is a one piece woven (“OPW”) construction. An inflatable curtain having an OPW construction includes yarns that are woven to form multilayer portions with overlying panels and single layer portions that help define an inflatable volume of the curtain. The weave density in the single layer portions is typically increased over that of the individual panels because the single layer portions include the yarns of both panels.

### SUMMARY OF THE INVENTION

The present invention relates to an inflatable vehicle occupant protection device. The protection device includes a one piece woven substrate that defines an inflatable volume of the protection device. Permeability reducing layers are applied to an outer surface of the substrate. The permeability reducing layers include a first permeability reducing layer comprising an adhesive film extruded onto the outer surface of the substrate and a second permeability reducing layer applied over the adhesive film.

The present invention also relates to an inflatable vehicle occupant protection device including a one piece woven substrate that defines an inflatable volume of the protection device. Permeability reducing layers are applied to an outer surface of the substrate. The permeability reducing layers include an adhesive film extruded onto the outer surface of the substrate and a pre-formed film laminated onto the extruded adhesive film.

The present invention further relates to an inflatable vehicle occupant protection device including a one piece woven substrate that defines an inflatable volume of the protection device. Permeability reducing layers are applied to an outer surface of the substrate. The permeability reducing layers include an adhesive film applied to the outer surface of the substrate and a coating coated over the adhesive film.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of an apparatus for helping protect an occupant of a vehicle, illustrating the apparatus in a deflated condition;

FIG. 2 is a schematic view of the apparatus of FIG. 1 in an inflated condition;

FIG. 3 is a sectional view of the apparatus taken generally along line 3-3 in FIG. 2;

FIG. 4A shows diagrammatically a system for laminating a substrate, according to a first embodiment of the present invention;

FIG. 4B shows an magnified view of a portion of an OPW fabric formed via the system of FIG. 4A;

FIG. 5A shows diagrammatically a system for laminating a substrate, according to a second embodiment of the present invention;

FIG. 5B shows an magnified view of a portion of an OPW fabric formed via the system of FIG. 5A; and

FIG. 5C shows diagrammatically an alternate system for laminating a substrate in accordance with the second embodiment of the present invention.

### DESCRIPTION OF EMBODIMENTS

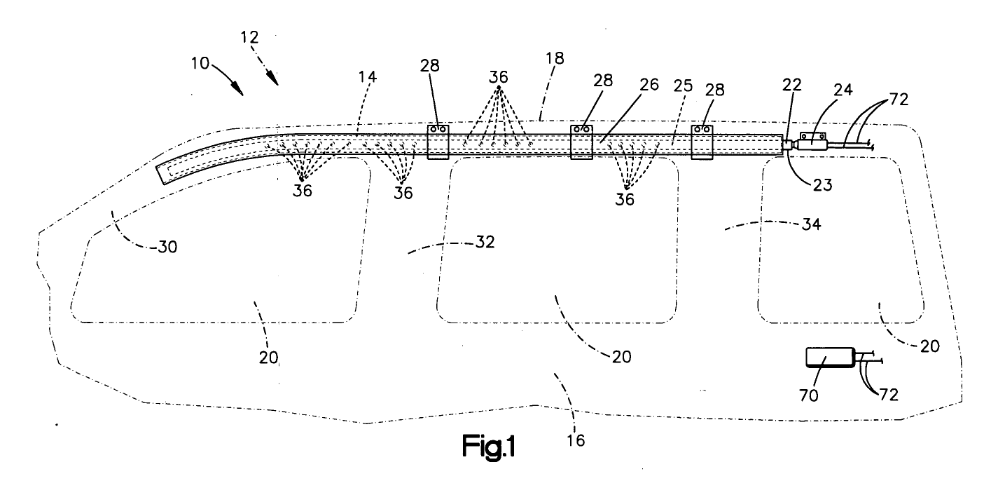

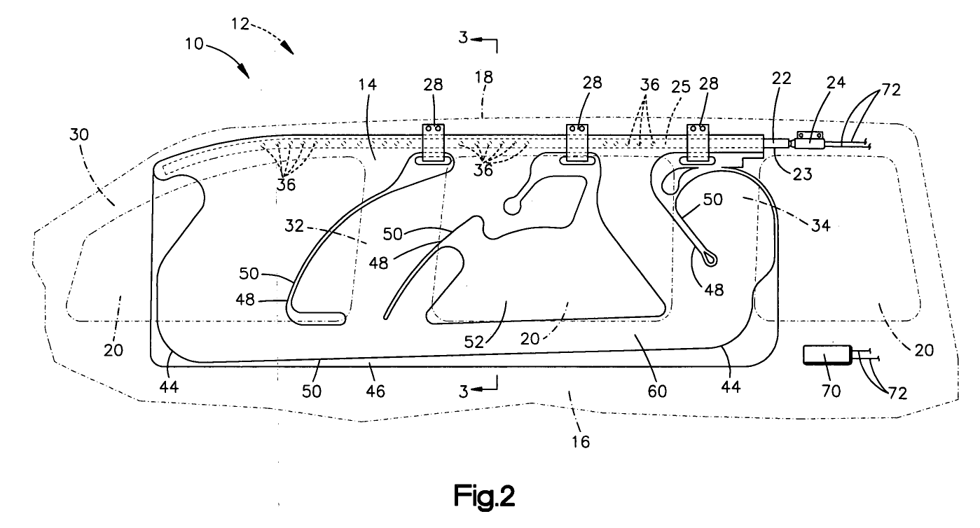

An apparatus 10 helps to protect an occupant of a vehicle 12. As shown in FIGS. 1 and 2, the apparatus 10 includes an inflatable vehicle occupant protection device in the form of an inflatable curtain 14. The present invention may include an inflatable vehicle occupant protection device in an alternative form, such as a driver front impact air bag, a passenger front impact air bag, a side impact air bag, an inflatable seat belt, or an inflatable knee bolster.

The inflatable curtain 14 is mounted adjacent a side structure 16 of the vehicle 12 and a roof 18 of the vehicle. The side structure 16 of the vehicle 12 includes side windows 20, an A pillar 30, a B pillar 32, and a C pillar 34. An inflator 24 is connected in fluid communication with the inflatable curtain 14 through a fill tube 22.

The fill tube 22 has a first end portion 23 for receiving fluid from the inflator 24. The fill tube 22 may be connected directly to the inflator 24 or a manifold (not shown) may connect the fill tube to the inflator. The fill tube 22 has a second end portion 25 disposed in the inflatable curtain 14. The fill tube 22 includes openings 36 through which inflation fluid is directed into inflatable curtain 14. The fill tube 22 may be constructed of any suitable material, such as plastic, metal or fabric. As a further alternative, those skilled in the art will appreciate that the fill tube 22 may be omitted, in which case the inflator 24 may be connected directly to the inflatable curtain 14.

The inflator 24 contains a stored quantity of pressurized inflation fluid (not shown) in the form of a gas for inflating the inflatable curtain 14. The inflator 24 alternatively could contain a combination of pressurized inflation fluid and ignitable material for heating the inflation fluid, or could be a pyrotechnic inflator that uses the combustion of gas-generating material to generate inflation fluid. As a further alternative, the inflator 24 could be of any suitable type or construction for supplying a medium for inflating the inflatable curtain 14.

The apparatus 10 includes a housing 26 (FIG. 1) that stores the inflatable curtain 14 in a deflated condition. The fill tube 22, the deflated inflatable curtain 14, and the housing 26 have an elongated configuration and extend along the vehicle roof 18 and along the side structure 16 of the vehicle 12 above the side windows 20. The fill tube 22, inflatable curtain 14, and housing 26 are connected to the vehicle 12 by means such as brackets 28.

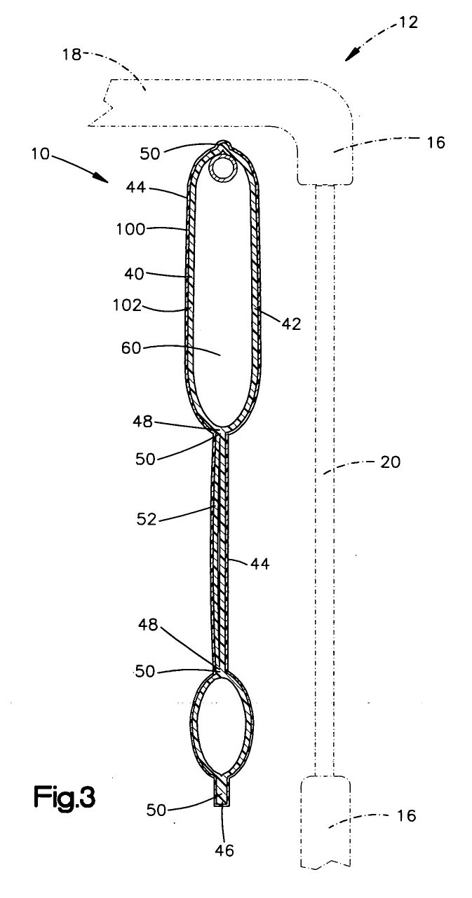

Referring to FIG. 3, the inflatable curtain 14 has an OPW construction and comprises first and second panels 40 and 42 that can be spaced apart from one another and that are arranged in an overlying manner. The inflatable curtain 14 also includes single layers 50 of woven material. The single layers 50 include a single layer 46 that extends along at least a portion of an outer edge 44 (FIGS. 2 and 3) of the inflatable curtain 14. The single layers 50 may also include single layers 48 spaced away from the outer edge 44.

The single layers 50 help define an inflatable volume 60 of the inflatable curtain 14. The single layers 50 may also help define inflatable chambers within the inflatable volume 60. The single layers 48 may also form non-inflatable portions of the inflatable curtain 14 positioned within the inflatable volume 60. For example, in the embodiment illustrated in FIG. 2, the single layers 48 help define a non-inflatable portion 52 of the inflatable curtain 14.

The vehicle 12 includes a sensor (shown schematically at 70 in FIGS. 1 and 2) for sensing the occurrence of an event for which inflation of the inflatable curtain 14 is desired, such as a side impact, a vehicle rollover, or both. Upon sensing the event, the sensor 70 provides an electrical signal over lead wires 72 to the inflator 24. The electrical signal causes the inflator 24 to be actuated in a known manner. The inflator 24 discharges fluid under pressure through fill tube 22, which directs the fluid into the inflatable curtain 14.

The inflatable curtain 14 inflates under the pressure of the inflation fluid from the inflator 24. The housing 26 (FIG. 1) opens, and the inflatable curtain 14 inflates away from the roof 18 in a downward direction as shown in the drawings and in a downward direction with respect to the direction of forward vehicle travel into the position illustrated in FIGS. 2 and 3. The inflatable curtain 14, when inflated, is positioned between the side structure 16 of the vehicle 12 and any occupant of the vehicle. When the inflatable curtain 14 is in the position illustrated in FIGS. 2 and 3, the second panel 42 (FIG. 3) is in an outboard position, adjacent the side structure 16 of the vehicle 12 between the first panel 40 and the side structure.

The inflatable curtain 14, when inflated, helps to protect a vehicle occupant in the event of a vehicle rollover or a side impact to the vehicle 12. The inflatable curtain 14, when inflated, helps to absorb the energy of impacts with the curtain and helps to distribute the impact energy over a large area of the curtain.

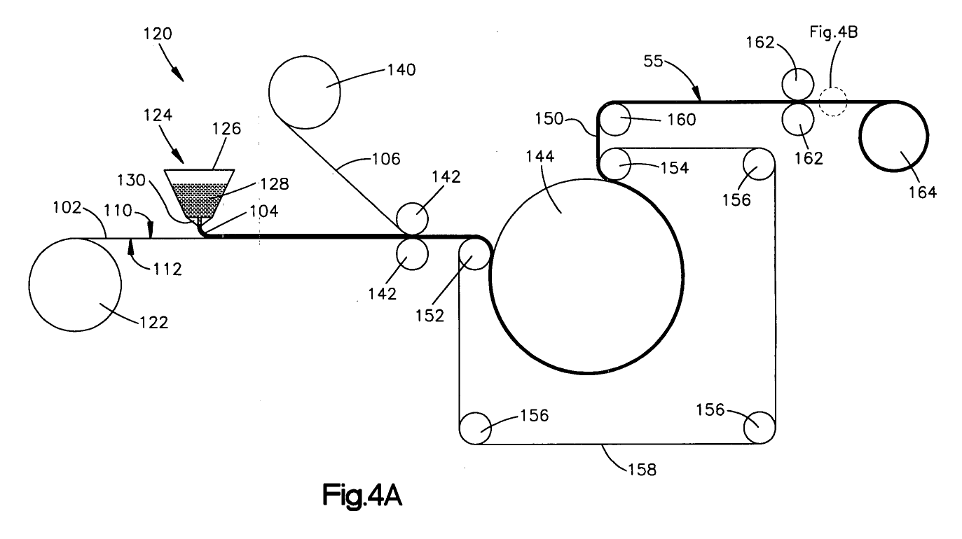

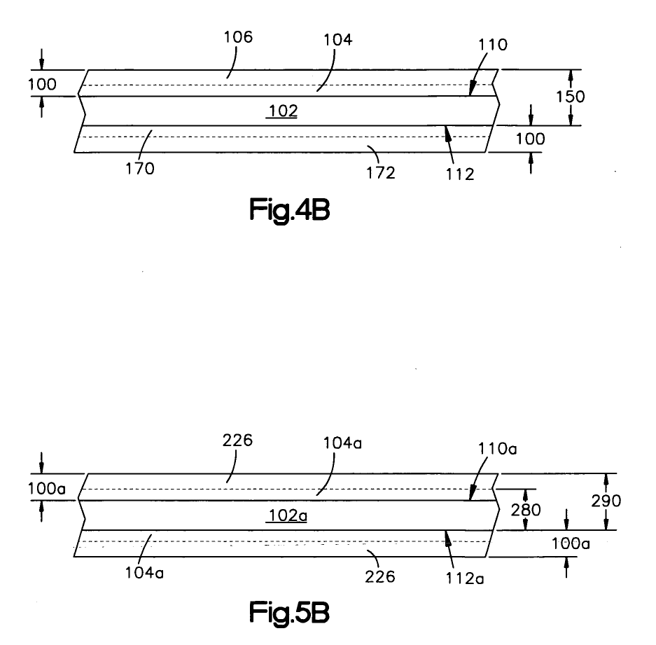

Referring to FIGS. 3 and 4B, according to the present invention, the inflatable curtain 14 includes permeability reducing layers 100 applied to outer surfaces of the OPW material of the curtain. Particularly, the permeability reducing layers 100 are applied to the first and second panels 40 and 42, the single layers 50, and the non-inflatable portion 52 on outer surfaces of the OPW material of the inflatable curtain 14.

In this description of the present invention, the permeability reducing layers 100 are described as being applied to a substrate 102. According to the present invention, the substrate 102 may comprise an OPW fabric including multiple inflatable curtains 14 that are cut from the substrate after the permeability reducing layers 100 are applied. Those skilled in the art, however, will appreciate that the substrate may comprise one or more inflatable curtains having a sewn fabric construction or a combination of OPW and sewn constructions. As another alternative, the substrate 102 may comprise inflatable vehicle occupant protection devices other than inflatable curtains, such as driver frontal impact air bags, passenger frontal impact air bags, side impact air bags, inflatable seat belts, and inflatable knee bolsters. As a further alternative, the substrate 102 may comprise any fabric used to form an inflatable vehicle occupant protection device.

The substrate 102 may have a variety of constructions. For example, the substrate 102 may be woven with a high filament count, high tenacity 470 dtex polyamide 66 (“PA66” or “nylon”) yarn. In this construction, the PA66 yarns may be with a relatively low weave density of 18×18 ends per centimeter per layer (ends/cm/layer). Alternative constructions may include weaving the 470 dtex yarns with a weave density of 20×20 ends/cm/layer or weaving 350 dtex yarns with a weave density of 23×23 ends/cm/layer. Alternative materials, such as polyamide 6 (“PA6”) yarns or polyethylene terephthalate (“PET”) yarns may also be used to construct the substrate 102. Round cross section yarns, flat cross section yarns, or a combination of round and flat cross section yarns may be used to construct the substrate 102. The yarn type, weave density, and yarn cross section may be selected to balance properties of strength, package size, and cost.

Referring to FIGS. 4A and 4B, according to a first embodiment of the present invention, the permeability reducing layers 100 comprise a pre-formed film 106 and an extruded adhesive film 104 that are laminated onto the substrate 102. The adhesive film 104 exhibits good sealing and adhesion properties, bonds well to the substrate 102, and facilitates receiving the pre-formed film 106. The pre-formed film 106 further seals the substrate 102 and exhibits good anti-blocking and low coefficient of friction properties.

As described in further detail below, the adhesive film 104 is extruded onto a first exterior surface 110 of the substrate 102 and the pre-formed film 106 is applied over the adhesive film. The adhesive and pre-formed films 104 and 106 are then laminated onto the substrate 102 through the application of heat and pressure, e.g., via a heated roller. This process is then repeated on the second, opposite, surface 112 of the substrate 102.

The pre-formed film 106 has a melt temperature higher than the melt temperature of the adhesive film 104. For example, according to the first embodiment of the present invention, the adhesive film 104 may comprise an extrusion grade urethane material, such as a polyether polyurethane material, and the pre-formed film 106 may comprise a co-polyester material, such as ARNITEL PL 5110, which is commercially available from DSM Engineering Plastics B.V. of Sittard, The Netherlands, or under the trademark HYTREL, which is commercially available from E.I. DuPont de Nemours and Company of Wilmington, Del. In this example, the extrusion grade polyether polyurethane adhesive film 104 may have a glass transition point of approximately −40° C. and an approximate melt temperature of about 190° C., and the co-polyester pre-formed film 106 may having a glass transition temperature of approximately −60° C., and an approximate melt temperature of about 220° C. The extrusion grade polyether polyurethane adhesive film 104 is extruded onto the substrate 102 at a thickness of about 35-50 μm, which corresponds to about 40-57 g/m². The co-polyester pre-formed film 106 has a thickness of about 15 μm.

Additives, such as flame retardants and anti-oxidants, may be added to the adhesive film 104 in order to provide environmental aging stability and to achieve various industry specification requirements. For example, these additives may be added to meet FMVSS 302, which specifies the burn resistance requirements for materials used in the occupant compartments of motor vehicles.

FIG. 4A illustrates a system 120 for forming the permeability reducing layers 100 on the substrate 102. The system 120 applies the adhesive film 104 and pre-formed film 106 to the substrate 102 during the manufacture of the inflatable curtain 14. The system 120 includes a first stock wheel 122 upon which a length of the substrate 102 is wound. The substrate 102 wound on the first stock wheel 122 may, for example, include the substrate portion of multiple inflatable curtains 14 that are to be cut out after the permeability reducing layers 100 are applied.

The system 120 also includes an extruder 124 for extruding the adhesive film 104 onto the substrate 102. The extruder 124 may have any known construction. For example, the extruder 124 may include a hopper 126 for storing a resin 128 that is melted to form the adhesive film 104, which is extruded onto the substrate 102 via an extrusion tool 130, such as a slot extrusion die. Alternative means (not shown), such as a rotary screen process, could be used to apply the resin 128 to the substrate 102.

The extruder 124 heats and melts the resin 128 and extrudes the adhesive film 104 onto the first surface 110 of the substrate 102. The extrusion rate of the extruder 124 and the feed rate at which the substrate 102 is fed from the first stock wheel 122 are controlled to achieve the prescribed thickness and weight of the adhesive film 104. For example, the extrusion rate and feed rate may be controlled to achieve a thickness in the range of about 35-50 μm, which would produce a corresponding weight range about 40-57 g/m².

The system 100 includes a second stock wheel 140 upon which the pre-formed film 106 is wound. The second stock wheel 140 is located downstream from the extruder 124. After the adhesive film 104 is applied to the first surface 110 of the substrate 102, the pre-formed film 106 is unwound from the second stock wheel 140 and applied overlying the adhesive film. Nip rollers 142 apply pressure to the pre-formed film 106, adhesive film 104, and substrate 102 to provide an initial set of the film on the substrate and to help prevent air pockets from forming between the topical film and the substrate.

Subsequent to the nip rollers 142, heat and pressure are applied via a heated drive roller 144 to the pre-formed film 106 and adhesive film 104 layers. The heat and pressure help cure the adhesive film 104 and secure the pre-formed film 106 to the substrate 102 to form a laminate 150. The laminate 150 includes the substrate 102 with the pre-formed film 106 and the adhesive film 104 applied to the first surface 110. The pressure required to cure the adhesive in forming the laminate 150 is controlled by first and second pressure rollers 152 and 154. A series of idler rollers 156 connected through a belt 158 control the rotation of the heated drive roller 144. Alternatively, the rotation of the heated drive roller 144 could be controlled by a motor (not shown) in either a direct connection or through a gear assembly attached to the drive roller.

The laminate 150 exits the heated drive roller 144 and passes over a second idler roller 160 and through second nip rollers 162 that apply pressure to the laminate. This completes formation of the permeability reducing layer 100 on the first side 110 of the substrate 102. The laminate 150 accumulates on a windup roller 164.

The permeability reducing layer 100 is then formed on the second side 112 of the substrate 102 using a system similar or identical to the system 120 of FIG. 4A. The laminate 150 is fed into this system, which forms the permeability reducing layer 100 on the second side 112 of the substrate 102 in a manner similar or identical to that described above in regard to the permeability reducing layer formed on the first surface 110 of the substrate.

More specifically, referring to FIG. 4B, the permeability reducing layer 100 is formed on the second side 112 of the substrate 102 by extruding an adhesive film layer 170 onto the second side of the substrate, applying a pre-formed film 172 over the adhesive film layer, and curing the adhesive film via heat and pressure. This produces a double-laminated (i.e., laminated on both the first and second surfaces 110 and 112) substrate 102. The inflatable curtains 14 are then cut individually from the laminated substrate 102 using, for example, laser cutting equipment (not shown).

The construction of the inflatable curtain 14 in accordance with the present invention provides an effectively sealed curtain with reduced material costs. The substrate 102 may be woven with a relatively low weave density and the permeability reducing layers 100 may have a relatively low weight per unit area. Reduced costs are further facilitated through the use of a single pre-formed film layer 106 in combination with an extruded film layer 104. This construction can eliminate the need for release liners associated with multiple pre-formed film layers. This construction can also eliminate the need for relatively high weight per unit area coatings and the costly solvents that may be associated with those coatings.

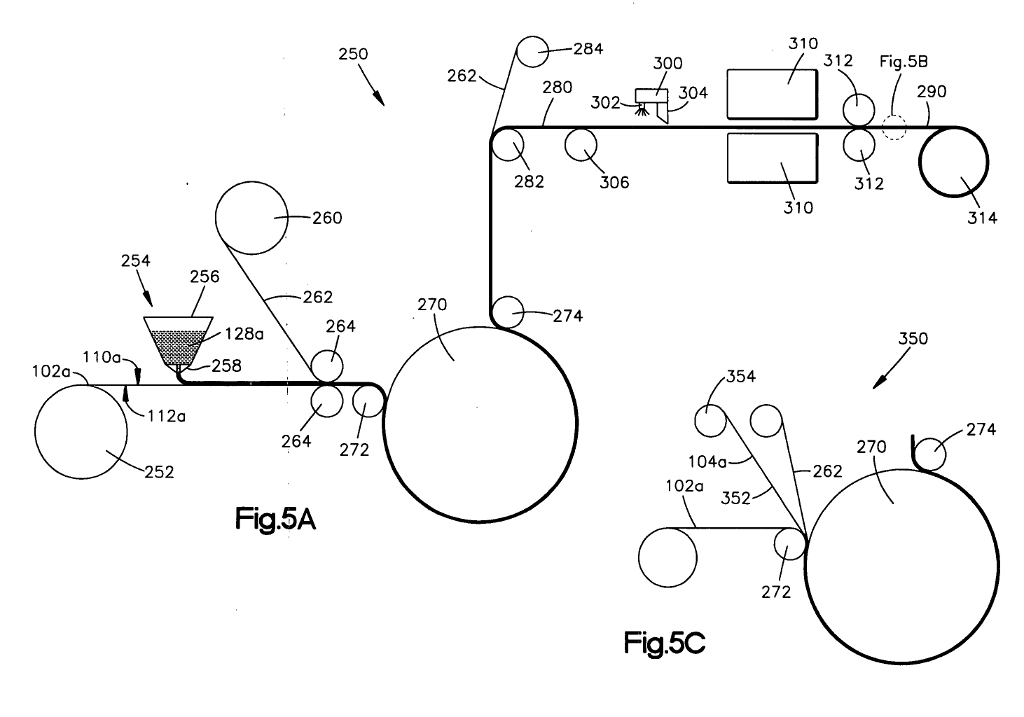

A second embodiment of the present invention is illustrated in FIGS. 5A and 5B. The second embodiment of the invention is similar to the first embodiment of the invention illustrated in FIGS. 4A and 4B. Accordingly, numerals similar to those of FIGS. 4A and 4B will be utilized in FIGS. 5A and 5B to identify similar components, the suffix letter “a” being associated with the numerals of FIGS. 5A and 5B to avoid confusion.

Referring to FIG. 5B, according to the second embodiment of the present invention, the substrate 102a includes permeability reducing layers 100a that help reduce the gas permeability of the substrate. The substrate 102a may be similar or identical to that described above in regard to the first embodiment of the present invention. The permeability reducing layers 100a comprise an adhesive film 104a applied to the substrate 102a and a relatively thin coating 226 applied over the adhesive film. The adhesive film 104a exhibits good sealing and adhesion properties, bonds well to the substrate 102a, facilitates receiving the coating 226. The coating 226 further seals the substrate 102a and exhibits good anti-blocking and low coefficient of friction properties.

As described below, the adhesive film 104a may be an extruded film or a pre-formed film. The adhesive film 104a is laminated to first surface 110a of the substrate 102a using heat and pressure, e.g., via heated roller. Then, the coating 226 is applied, e.g., via spray and knife coating, over the laminated film. This process is then repeated on the second surface 112a of the substrate 102a.

In one example of a construction according to the second embodiment of the present invention, the adhesive film 104a may comprise an extrusion grade urethane, such as a polyether polyurethane or a polyester polyurethane. The adhesive film 104a may have a glass transition point of approximately −35° C. and a Vicat softening point of about 80° C. Additives, such as flame retardants and anti-oxidants, may be added to the adhesive film 104a in order to provide environmental aging stability and to achieve various industry specification requirements. For example, these additives may be added to meet FMVSS 302, which specifies the burn resistance requirements for materials used in the occupant compartments of motor vehicles. The extrusion grade polyether polyurethane adhesive film 104a is extruded onto the substrate 102a at a thickness of about 35-50 μm, which corresponds to about 40-57 g/m².

The coating 226 may comprise a urethane, such as a polyether polyurethane, that is harder than the adhesive film 104a and has a Vicat softening point higher than that of the adhesive film. To help improve its anti-blocking properties, the coating 226 may also comprise a diatomaceous earth material. The coating 226 may further comprise a coefficient of friction reducing material. An example of a coefficient of friction reducing material is DOW CORNING MB50-010 MASTERBATCH, which is commercially available from Dow Corning of Midland, Mich. DOW CORNING MB50-010 MASTERBATCH is an ultra-high molecular weight (UHMW) siloxane polymer dispersed in HYTREL (E.I. DuPont de Nemours & Co., Wilmington, Del.). Additional additives, such as flame retardants and anti-oxidants, may be added to the coating 226 in order to provide environmental aging stability and to achieve various industry specification requirements. For example, these additives may be added to meet FMVSS 302.

The coating 226 may have alternative compositions. For example, the coating 226 may comprise a silicon material, such as a liquid silicon rubber, which could eliminate the need for solvents. As another alternative, the coating 226 may comprise co-polyester materials dissolved in a solvent. Suitable examples include ARNITEL® PL 5110 (DSM Engineering Plastics B.V. of Sittard, The Netherlands) and HYTREL® (E.I. DuPont de Nemours & Co., Wilmington, Del.).

The polyether polyurethane, anti-blocking additives, friction reducing additives, flame retardant additives, and anti-oxidant additives are dissolved in a solvent, such as dimethyl formamide (DMF), to a ratio of about 30% solids. The viscosity of the coating 226 is about 15,000-30,000 centipoises (cps). A relatively thin layer of the coating 226 is applied over the adhesive film 104a with a weight of about 10-15 g/m². The coating 226 is then cured, e.g., via an oven. This process is then repeated, applying the adhesive film 104a and coating 226 on the second surface 112a of the substrate 102a, in a manner similar or identical to that described above.

FIG. 5A illustrates a system 250 for forming the permeability reducing layer 100a on the first side 110a of the substrate 102a. The system 250 applies the adhesive film 104a and the coating 226 to the substrate 102a. The system 250 includes a first stock wheel 252 upon which a length of the substrate 102a is wound. The substrate 102a wound on the first stock wheel 202 may, for example, include the substrate portion of multiple inflatable curtains that are to be cut out after the permeability reducing layers 100a are applied.

The system 250 also includes an extruder 254 for extruding the adhesive film 104a onto the substrate 102a. The extruder 254 may have any known construction. For example, the extruder 254 may include a hopper 256 for storing a resin 128a that is melted to form the adhesive film 104a, which is extruded onto the substrate 102a via an extrusion tool 258, such as a slot extrusion die. Alternative means (not shown), such as a rotary screen process, could be used to apply the resin 128a to the substrate 102a.

The extruder 254 heats and melts the resin 128a and extrudes the adhesive film 104a onto the first surface 110a of the substrate 102a. The extrusion rate of the extruder 254 and the feed rate at which the substrate 102a is fed from the first stock wheel 252 are controlled to achieve the prescribed thickness and weight of the resulting adhesive film 104a. For example, as described above, a suitable thickness may be in the range of about 35-50 μm and would produce a corresponding weight range about 40-57 g/m².

The system 250 includes a second stock wheel 260 upon which a release liner 262 is wound. The second stock wheel 260 is located downstream from the extruder 254. After the adhesive film 104a is applied to the first surface 110a of the substrate 102a, the release liner 262 is unwound from the second stock wheel 260 and applied onto the adhesive film. Nip rollers 264 apply pressure to the release liner 262, adhesive film 104a, and substrate 102a. Subsequent to the nip rollers 264, heat and pressure are applied to the release liner 262 and adhesive film 104a layer via a heated roller 270. The heat and pressure help cure the adhesive film 104a.

The release liner 262 helps prevent the adhesive film 104a from sticking to a heated roller 270. Alternatively, the heated roller 270 may be treated with a non-stick material, such as those available under the trademark TEFLON, which is commercially available from the E.I. DuPont de Nemours and Company of Wilmington, Del. Such non-stick materials help eliminate adhesion problems and the need for the release liner 262. The system 250 may also include pressure rollers 272 and 274 that act in concert with the heated roller 270 to apply heat and pressure to the substrate 102a, adhesive film 104a, and release liner 262. The heat and pressure help cure and laminate the adhesive film 104a onto the substrate 102a, thus forming a laminate 280 comprising the substrate and the adhesive film 104a laminated on the substrate. The laminate 280 exits the heated roller 270 and passes along an idler roller 282, at which point the release liner 262 is removed and taken up on a windup roller 284.

The system 250 also includes a coating apparatus 300 that includes a nozzle 302 and a knife 304. After the release liner is removed 262 from the laminate 280, the laminate passes adjacent or through the coating apparatus 300, which applies the coating 226 on top of the adhesive film 104a. The nozzle 302 sprays the coating 226 onto the laminate 280 and the knife 304 spreads the coating to provide the desired thickness and weight and to provide even and uniform coverage. The amount of coating material 226 sprayed onto the laminate 280 can be adjusted, for example, by adjusting a tension roller 306 to adjust the proximity of the laminate to the coating nozzle 302. For example, the nozzle 302 may apply the coating 226 to the laminate 280 and the knife 304 may spread the coating to help achieve an even, uniform weight of about 10-15 g/m².

After the coating 226 is applied to the laminate 280, the coated laminate is passed through ovens 310 to dry or cure the coating. The ovens 310 may, for example, be tenter frame multi-zone convection ovens. The coating 226 is heated to a prescribed temperature for a prescribed duration. After the coating is cured, the coated laminate 290 is pressure treated by nip rollers 212, at which point formation of the permeability reducing layer 100a on the first surface 110a of the substrate 102a is complete. The substrate 102a with the permeability reducing layer 100a formed on its first surface 110a is then collected on windup roller 314.

The permeability reducing layer 100a is then formed on the second side 112a of the substrate 102a using a system similar or identical to the forming system 250 of FIG. 5A. The coated laminate 290 is fed into this system, which forms the permeability reducing layer 100a on the second side 112a of the substrate 102a in a manner similar or identical to that described above in regard to the permeability reducing layer formed on the first surface 110a of the substrate.

More specifically, referring to FIG. 5B, the permeability reducing layer 100a is formed on the second side 112a of the substrate 102a by extruding an adhesive film 104a onto the second side of the substrate, curing the adhesive film layer via heat rolling, applying a coating 226 onto the cured film layer, and curing the coating via heat in an oven. This produces an substrate 102a, with permeability reducing layers 100a formed on opposite surfaces 110a and 112a of the substrate, from which the inflatable curtains 14 can be cut using, for example, a laser cutting procedure (not shown).

FIG. 5C illustrates a system 350 for using an alternative process to apply the adhesive film 104a to the substrate 102a. According to this alternative process, the adhesive film 104a comprises a pre-extruded film 352 that is unwound from a stock wheel 354 and that is disposed between the substrate 102a and the release liner 262. In this alternative process, the adhesive film 104a is cured using pressure and heat applied via the heated roller 270 and the pressure rollers 272 and 274. Once the adhesive film 104a is sufficiently cured, the release film 262 is removed and the coating (not shown in FIG. 5C) is applied in a manner similar or identical to that described above in regard to FIGS. 5A and 5B. The release liner 262 may be optional, as described above, where the heated roller 270 includes a non-stick coating.

The pre-extruded film 352 may be formed in a variety of manners. For example, the pre-extruded film 352 could be formed using a single die blow molded extrusion process to produce the film with collapsed layers. The die blow molding process creates a film bubble preferably having an approximate wall thickness of 25 μm. The bubble is then allowed to collapse on itself creating an effective film thickness of 50 μm, which equates to a weight of approximately 57 g/m². Using the blow molding collapsing layer process eliminates the need to add anti-blocking waxes or lubricants to separate the collapsed layers of the film bubble after the extrusion process.

As another example, the pre-extruded film 352 could be formed using a single die blow molded extrusion process to produce the film with separate layers. According to this process, a higher level of flame retardant is added, which makes it possible to add wax or lubricants to the formulation. This, in turn, allows the layers to be separated, thereby allowing for a film thickness as low as 25 μm.

As another example, the pre-extruded film 352 could be formed using a blow mold co-extrusion process. The blow mold co-extrusion process forms an inner bubble with a carrier material, such as polyethylene. The adhesive film is extruded on the outside of the bubble. This allows the film thickness to remain below 50 μm without adding wax or lubricants.

As a further example, the pre-extruded film 352 could be formed using a slot die extrusion process. According to this process, a single adhesive film layer is extruded onto a carrier material, such as polyethylene, which is disposed of downstream in the process. Use of the carrier material allows for an adhesive film thickness of less than 50 μm without adding wax or lubricants.

The construction of the inflatable curtain in accordance with the second embodiment of the present invention provides an effectively sealed curtain with reduced material costs. The substrate 102a may be woven with a relatively low weave density and the permeability reducing layers 100a may have a relatively low weight per unit area. Reduced costs are further facilitated through the use of an extruded film layer 104a and a coating layer 226 that eliminates the high costs associated with pre-formed materials. Through the use of non-stick heated rollers, this construction can eliminate the need for release liners associated with multiple pre-formed film layers. This construction also can also eliminate the need for relatively high weight per unit area coatings and the costly solvents that may be associated with those coatings.

From the above description of the invention, those skilled in the art will perceive improvements, changes and modifications. For example, the reduced permeability fabric constructions of the present invention are illustrated as being implemented in the construction of an inflatable curtain. The reduced permeability fabric constructions of the present invention could, however, be applied to any inflatable vehicle occupant protection device, such as driver frontal impact air bags, passenger frontal impact air bags, side impact air bags, inflatable seat belts, and inflatable knee bolsters. Such improvements, changes and modifications within the skill of the art are intended to be covered by the appended claims.

Having described the invention, the following is claimed:

1. An inflatable vehicle occupant protection device comprising:
a one piece woven substrate that defines an inflatable volume of the protection device, and permeability reducing layers applied to an outer surface of the substrate, the permeability reducing layers comprising:
a first permeability reducing layer comprising an adhesive film extruded onto the outer surface of the substrate; and
a second permeability reducing layer applied over the adhesive film.

2. The inflatable vehicle occupant protection device recited in claim 1, wherein the second permeability reducing layer comprises a pre-formed film laminated over the adhesive film.

3. The inflatable vehicle occupant protection device recited in claim 2, wherein the pre-formed film has a higher melt temperature than the adhesive film.

4. The inflatable vehicle occupant protection device recited in claim 2, wherein the adhesive film comprises an extrusion grade urethane.

5. The inflatable vehicle occupant protection device recited in claim 2, wherein the adhesive film comprises a polyether polyurethane.

6. The inflatable vehicle occupant protection device recited in claim 5, wherein the adhesive film has a glass transition point of about −40° C. and a melt temperature of about 190° C.

7. The inflatable vehicle occupant protection device recited in claim 5, wherein the adhesive film is extruded onto the substrate with a thickness in the range of about 35-50 μm.

8. The inflatable vehicle occupant protection device recited in claim 5, wherein the adhesive film is extruded onto the substrate with a weight of about 40-57 g/m².

9. The inflatable vehicle occupant protection device recited in claim 2, wherein the pre-formed film comprises a pre-formed co-polyester film.

10. The inflatable vehicle occupant protection device recited in claim 9, wherein said pre-formed co-polyester film has a thickness of about 15 μm.

11. The inflatable vehicle occupant protection device recited in claim 9, wherein the pre-formed co-polyester film has a glass transition temperature of about −60° C. and a melt temperature of about 220° C.

12. The inflatable vehicle occupant protection device recited in claim 1, wherein the second permeability reducing layer comprises a coating applied over the adhesive film.

13. The inflatable vehicle occupant protection device recited in claim 12, wherein the adhesive film comprises an extrusion grade urethane.

14. The inflatable vehicle occupant protection device recited in claim 12, wherein the adhesive film comprises one of a polyether polyurethane and a polyester polyurethane.

15. The inflatable vehicle occupant protection device recited in claim 12, wherein the adhesive film has a glass transition point of about −35° C. and a Vicat softening point of about 80° C.

16. The inflatable vehicle occupant protection device recited in claim 12, wherein the adhesive film is extruded onto the substrate with a thickness in the range of about 35-50 μm.

17. The inflatable vehicle occupant protection device recited in claim 12, wherein the adhesive film is extruded onto the substrate with a weight of about 40-57 g/m².

18. The inflatable vehicle occupant protection device recited in claim 12, wherein the coating comprises a polyether polyurethane coating.

19. The inflatable vehicle occupant protection device recited in claim 18, wherein the polyether polyurethane coating has a viscosity of about 15,000-30,000 centipoise.

20. The inflatable vehicle occupant protection device recited in claim 18, wherein the polyether polyurethane coating is applied with a weight of about 10-15 g/m².

21. The inflatable vehicle occupant-protection device recited in claim 12, wherein the coating comprises a silicon coating.

22. The inflatable vehicle occupant protection device recited in claim 12, wherein the coating comprises a co-polyester coating.

23. An inflatable vehicle occupant protection device comprising:
a one piece woven substrate that defines an inflatable volume of the protection device, and permeability reducing layers applied to an outer surface of the substrate, the permeability reducing layers comprising:
an adhesive film extruded onto the outer surface of the substrate; and
a pre-formed film laminated onto the extruded adhesive film.

24. An inflatable vehicle occupant protection device comprising:
a one piece woven substrate that defines an inflatable volume of the protection device, and permeability reducing layers applied to an outer surface of the substrate, the permeability reducing layers comprising:
an adhesive film applied to the outer surface of the substrate; and
a coating coated over the adhesive film.

25. The inflatable vehicle occupant protection device recited in claim 24, wherein the adhesive film comprises an extruded adhesive film.

26. The inflatable vehicle occupant protection device recited in claim 24, wherein the adhesive film comprises a pre-formed adhesive film.
